(19) United States
(12) Patent Application Publication
(10) Pub. No.: US 2023/0162713 A1
(43) Pub. Date: May 25, 2023

(54) CONTROL SYSTEM FOR DIALS AND SWITCHES, BRACKET APPARATUS, AND METHODS OF USING THE SAME

(71) Applicant: Kyle Scheppman, Algonquin, IL (US)

(72) Inventor: Kyle Scheppman, Algonquin, IL (US)

(21) Appl. No.: 17/533,798

(22) Filed: Nov. 23, 2021

(51) Int. Cl. G10H 1/00; G10H 1/34

(52) U.S. Cl. CPC G10H 1/0083; G10H 1/0008; G10H 1/348; G10H 2240/211

(57) ABSTRACT

A a control system for dials and switches allows one or more dials and/or switches to be controlled remotely via a wired or a wireless communication. Preferably, the control system is utilized by a user with one or more expression pedals and/or a footswitches to control audio equipment, such as, for example, an amplifier or other audio processor apparatus. Methods of using the same are further provided.

### TECHNICAL FIELD

The present invention relates to a control system for dials and switches. Specifically, the control system allows one or more dials and/or switches to be controlled remotely via a wired or a wireless communication. Preferably, the control system is utilized by a user with one or more expression pedals and/or a footswitches to control audio equipment, such as, for example, an amplifier or other audio processor apparatus. Methods of using the same are further provided.

### BACKGROUND

Electronic equipment generally has turnable dials and switches for activation and/or changing of a setting. For example, in an audio device, such as an amplifier, there may be switches for activation of the audio device itself and for turning on or off certain settings. Dials are typically used to change the settings, such as intensity or other parameters, for example. In a simple example, an audio amplifier may have an on/off switch, one or more channel gain dials, and a master gain dial. In other examples, audio amplifiers may have many more settings, such as equalizer settings (bass, midrange, treble), audio pre-sets, modulation settings, reverb settings, overdrive, and many other settings.

A musician will often use a combination of the settings on an audio device, such as an audio amplifier or an audio processor, to achieve the desired sound when playing a musical instrument. For example, a guitar player may wish to adjust overdrive, bass, midrange, treble, and volume simultaneously to achieve a particular guitar sound.

It is often difficult to adjust a plurality of settings simultaneously on an audio device. Specifically, to achieve the proper sound, as noted above, many settings may require adjustments at the same time and quickly. A musician that is in the middle of a live performance, for example, often does not have sufficient time to make the necessary adjustments to achieve the sound desired. And in many cases, musicians must change from one sound to another within a single song many times. Typically, adjusting these settings requires manually making the adjustments to the various dials and switches as quickly as possible.

A need, therefore, exists for an improved control system for dials and switches on an electronic device. Specifically, a need exists for an improved control system for an audio device, such as, for example, an amplifier, a sound processor, or other like audio device.

Moreover, a need exists for an improved control system that allows a user to quickly make adjustments to one or a plurality of settings on the electronic device. Specifically, a need exists for an improved control system that allows a user to make adjustments to dials and switches simultaneously.

When manually making adjustments to settings, it is often difficult to make the adjustments to achieve the desired sound and to do so repeatedly from one time to another. For example, a user may determine particular settings for a desired sound but may forget the settings when attempting to recreate the desired sound.

A need, therefore, exists for an improved control system for dials and switches on an electronic device that allows a user to make consistent adjustments to achieve the desired sound. Moreover, a need exists for an improved control system for electronic devices that allows a user to make adjustments repeatedly from one time to another.

In addition, a need exists for an improved control system for dials and switches on an electronic device that is easy to use. Specifically, musicians are often unable to use their hands due to playing the instrument and require other control means, such as control means operated in other ways, such as with pedals and/or footswitches. A need, therefore, exists for an improved control system for dials and switches that allows a user to operate the same in other ways besides using their hands, such as by using foot pedals and footswitches.

Still further, known dial and switch adjustment control systems often allow for the automatic or pre-programmed adjustment of audio parameters, but often do not allow a user to make manual adjustments when necessary. For example, as a user utilizes a dial or switch control system, he or she may wish to make small adjustments to the control system to adjust the resulting sound. A need exists for an improved control system for dials and switches on an electronic device that allows manual adjustment as well as automatic and pre-programmed adjustments. More specifically, a need exists for an improved control system for dials and switches on an electronic device that allows manual adjustment without removal of the automatic and pre-programmed control system.

### SUMMARY OF THE INVENTION

The present invention relates to a control system for dials and switches. Specifically, the control system allows one or more dials and/or switches to be controlled remotely via a wired or a wireless communication. Preferably, the control system is utilized by a user with one or more expression pedals and/or a footswitches to control audio equipment, such as, for example, an amplifier or other audio processor apparatus. Methods of using the same are further provided.

To this end, in an embodiment of the present invention, a control system for controlling a plurality of dials and switches simultaneously is provided. The control system comprises: an electronic device comprising a first dial or switch; a first motor having a shaft, wherein the shaft interacts with the first dial or switch; a control panel, wherein the control panel controls the first motor which in turn controls the first dial or switch; a controller interconnected with the control panel, wherein manipulation of the controller causes the control panel to engage the motor, thereby controlling the first dial or switch; and a bracket comprising a base and a motor connection element, wherein the first motor connection element is connected to the first motor and is configured to hold the first motor in place on the bracket.

In an embodiment, the electronic device is an audio device.

In an embodiment, the electronic device is an audio amplifier.

In an embodiment, the motor connection element is rotatably connected to the base.

In an embodiment, the bracket comprises at least one foot extending from the base.

In an embodiment, the at least one foot is adjustable in position relative to the base.

In an embodiment, the motor connection element comprises an aperture, wherein the first motor comprises a housing and the housing comprises a shaft extending therefrom, wherein the shaft is disposed through the aperture on the motor connection element.

In an embodiment, the motor connection element comprises a vertical configuration and a horizontal configuration relative to the base.

In an embodiment, the electronic device comprises a second dial or switch and further comprises: a second motor having a shaft, wherein the shaft interacts with the second dial or switch,

In an embodiment, the motor connection element is connected to the second motor and is configured to hold the second motor in place on the bracket.

In an embodiment, the motor connection element comprises an aperture, wherein the first motor comprises a housing and the housing comprises a shaft extending therefrom, wherein the shaft extending from the first motor is disposed through the aperture on the motor connection element, and further wherein the second motor comprises a housing and the housing comprises a shaft extending therefrom wherein the shaft extending from the second housing is disposed through the aperture on the motor connection element.

In an embodiment, the motor connection element comprises a first aperture and a second aperture, wherein the first motor comprises a housing and the housing comprises a shaft extending therefrom, wherein the shaft extending from the first motor is disposed through the first aperture on the motor connection element, and further wherein the second motor comprises a housing and the housing comprises a shaft extending therefrom wherein the shaft extending from the second housing is disposed through the second aperture on the motor connection element.

In an embodiment, the first motor and the second motor and individually and separately controllable.

In an alternate embodiment of the present invention, a bracket for connecting a motor controller to a dial or switch on an electronic device is provided. The bracket comprises: a base element; a first sidewall extending from a first side of the base element; a second sidewall extending from a second side of the base element; and a motor connection element bridging between the first sidewall and the second sidewall, wherein the motor connection element is configured to hold a first motor thereon, the first motor having a shaft extending therefrom, wherein the shaft is configured to engage a dial or a switch on an electronic device.

In an embodiment, the motor connection element is configured to hold a second motor thereon.

In an embodiment, the motor connection element comprises a first aperture and the first motor is configured to be mounted within the first aperture.

In an embodiment, the motor connection element is configured to hold a second motor thereon, wherein the second motor is configured to be mounted within the first aperture.

In an embodiment, the motor connection element comprises a second aperture and the motor connection element is configured to hold a second motor thereon, wherein the second motor is configured to be mounted within the second aperture.

In an embodiment, the motor connection element comprises a vertical configuration and a horizontal configuration relative to the base, wherein the motor connection element is configured to rotate between the vertical configuration and the horizontal configuration.

In an embodiment, the bracket further comprises: an extension element having a first end and a second end, the first end of the extension element attached to the motor connection element, wherein the extension element is configured to hold the first motor thereon.

It is, therefore, an advantage and objective of the present invention to provide an improved control system for dials and switches on an electronic device.

Specifically, it is an advantage and objective of the present invention to provide an improved control system for an audio device, such as, for example, an amplifier or other like audio device.

Moreover, it is an advantage and objective of the present invention to provide an improved control system that allows a user to quickly make adjustments to a plurality of settings on the electronic device.

Specifically, it is an advantage and objective of the present invention to provide an improved control system that allows a user to make adjustment to dials and switches simultaneously.

Moreover, it is an advantage and objective of the present invention to provide an improved control system for dials and switches on an electronic device that allows a user to make adjustments to achieve the desired sound.

Further, it is an advantage and objective of the present invention to provide an improved control system for electronic devices that allows a user to make adjustments repeatedly from one time to another.

In addition, it is an advantage and objective of the present invention to provide an improved control system for dials and switches on an electronic device that is easy to use.

Still further, it is an advantage and objective of the present invention to provide an improved control system for dials and switches that allows a user to operate the same in other ways besides using their hands, such as by using foot pedals and footswitches.

Moreover, it is an advantage and objective of the present invention to provide an improved control system for dials and switches on an electronic device that allows manual adjustment as well as automatic and pre-programmed adjustments.

More specifically, it is an advantage and obj ective of the present invention to provide an improved control system for dials and switches on an electronic device that allows manual adjustment without removal of the automatic and pre-programmed control system.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a control system for dials and switches in an embodiment of the present invention.

FIG. 2 illustrates a perspective view of a control system bracket in an embodiment of the present invention.

FIG. 3 illustrates a perspective view of a control system bracket with controllable motor mounted thereon in an embodiment of the present invention.

FIG. 4 illustrates a perspective view of a control system bracket with a controllable motor mounted to an extension element in an embodiment of the present invention.

FIG. 5 illustrates a front view of a control system bracket in an alternate arrangement in an embodiment of the present invention.

FIG. 6 illustrates a perspective view of a control system bracket in a second configuration in an embodiment of the present invention.

FIG. 7 illustrates a perspective view of a control system bracket in a second configuration interconnected with a foot switch in an embodiment of the present invention.

### DETAILED DESCRIPTION OF THE PRESENTLY PREFERRED EMBODIMENTS

The present invention relates to a control system for dials and switches. Specifically, the control system allows one or more dials and/or switches to be controlled remotely via a wired or a wireless communication. Preferably, the control system is utilized by a user with one or more expression pedals and/or a footswitches to control audio equipment, such as, for example, an amplifier or other audio processor apparatus. Methods of using the same are further provided.

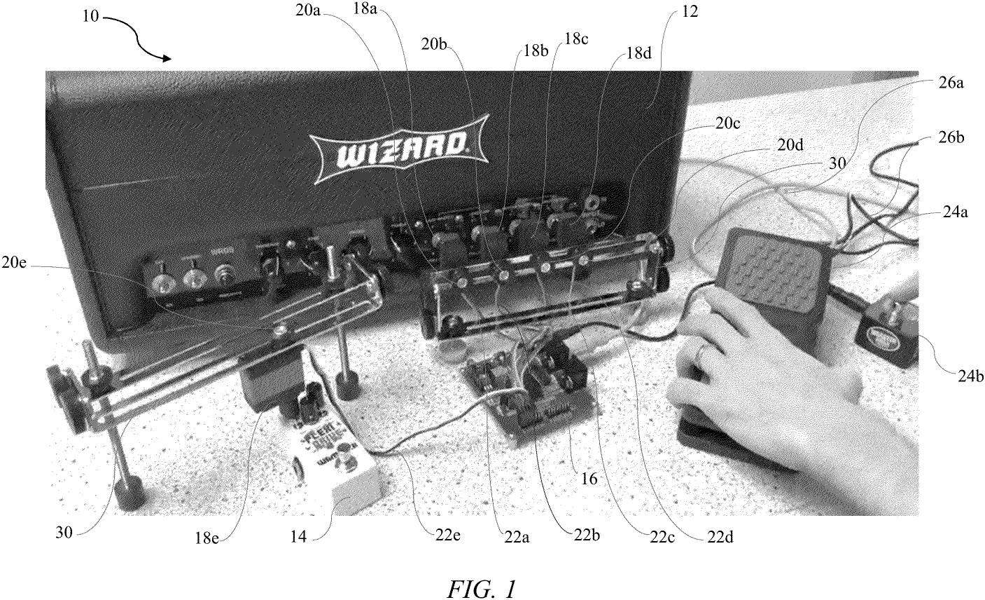

Now referring to the figures, wherein like numerals refer to like parts, FIG. 1 illustrates a perspective view of a control system 10 in an embodiment of the present invention. The control system 10 comprises a plurality of components that allow a user to control one or more dials and/or switches that may be on an electronic device. In the example shown in FIG. 1, the control system 10 alternately controls a plurality of dials or switches on an audio amplifier 12 and one or more dials or switches on a foot switch 14. More specifically, as illustrated herein, the control system 10 may control various dials and switches that control the sound generated by one or more musical instruments that may be electronically connected to the audio amplifier 12 and/or the foot switch 14, or any other electronic device, audio device, sound processor, or other like device that may affect the sound generated by the musical instruments. For example, one or more electric guitars may be connected to the audio amplifier 12 and/or the foot switch 14 such that, when the various dials and/or switches are manipulated on the audio amplifier 12 and/or the foot switch 14, the sound generated by the one or more electric guitars may be controlled.

Although the preferred embodiment shown and described herein relates to audio equipment, it should be noted that the present control system may be utilized on any electronic device having dials and/or switches, and the present invention should not be limited as described herein.

The control system 10 may comprise a control panel 16 having a programmable interface that may allow one or more motors 18a, 18b, 18c, 18d, 18e, or additional motors not shown herein, to be controlled thereby. The control panel 16 may be a programmable logic controller (PLC) that allows for the specification and control of the individual motors 18a-18e, or any number of motors, as needed. In general, the control panel 16 comprise input devices, internal logic to process the input data, and outputs that control the one or more motors 18a-18e, or any number of control motors, based on pre-programmed parameters. Preferably, the control panel 16 of the present invention may receive input based on MIDI communication protocol, although the control panel 16 may utilize any communication protocol apparent to one of ordinary skill in the art and the present invention should not be limited as described herein.

The one or more motors 18a-18e may be interconnected or otherwise engaged to dials and/or switches extending from the electronic device, such as the audio amplifier 12 and/or the foot switch 14, or any other electronic device apparent to one of ordinary skill in the art. For example, the one or more motors 18a-18e may be interconnected with the dials such that rotation of the motor may cause rotation of the dials. Alternatively, each motor 18a-18e may have a shaft and a tab for engaging a switch on an electronic device, such that the motor may cause the shaft and, therefore, the tab to rotate thereby engaging a switch that may have an up or down position, or an up, down, and mid position, for example. When the motor rotates in one direction, it may cause the tab to move the switch upwardly or downwardly, respectively. Likewise, when rotated in the opposite direction, it may cause the tab to move the switch oppositely. Thus, the motors 18a-18e may be utilized, as described herein, to turn dials and or engage on/off switches.

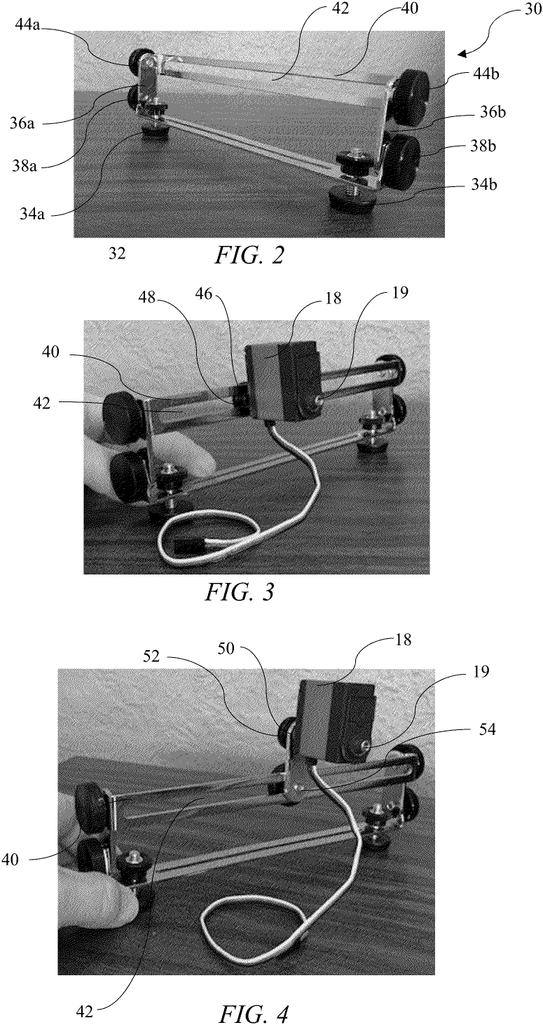

Specifically, each motor 18a-18e may comprise a housing having, on one side thereof, a shaft 19 extending therefrom that turns with the spinning of the motor therein, either directly or, more preferably, through a series of reduction gears. On a reverse side of each motor 18a-18e may be a threaded connection shaft 46 that is disposed through one or more brackets 30 that holds the motors 18a-18e in place via nuts 20a, 20b, 20c, 20d, 20e. Control leads 22a, 22b, 22c, 22d, 22e may extend from the control panel 16 and interconnect to the motors 18a-18e, thereby controlling the precise activation and control of the motors connected thereto. The bracket 30 is illustrated and described in more detail below in FIGS. 2-4. In a preferred embodiment, the control leads 22a-22e may extend from the bottom of the housing so as not to interfere with the connection to the bracket 30 as described in more detail below; however, it should be noted that the control leads 22a-22e may extend from any position and location of the housing and the invention should not be limited as described herein.

The control panel 16 may allow each of the individual motors 18a-18e to be individually controlled. Specifically, each of the motors 18a-18e may be individually programmed to move a certain amount upon receiving control signals generated by one or more controllers 24a, 24b. For example, controller 24a may be a foot pedal that may provide a plurality of positions between a fully up position and a fully pressed position, whereby the extent of motor spin of the motors 18a-18e may be controlled by the extent of movement of the foot pedal. Alternatively, controller 24b may be a switch that may have a small number of discrete positions, such as either on and off, or on, off and a mid-position. Each of the positions of the controllers may control various positions of one or more of the motors 18a-18e.

Moreover, each controller 24a, 24b, or any other controller, may control one or a plurality of motors 18a-18e or any number of motors. If controlling a plurality of motors, then the relative positions of each motor may be individually programmed based on the control signals received. For example, as illustrated in FIG. 1, controller 24a, shown as the foot pedal, for example, may control each of the four motors 18a-18d in different amounts and/or in different directions, such that pressing the foot pedal may cause the motors 18a-18d to all spin differently. Alternatively, each motor may be programmed individually to spin the same amount in the same direction thereby controlling each dial and/or switch to the same extent.

The controllers 24a, 24b, and any other controllers, may be interconnected to the control panel 16 via controller leads 26a, 26b, as illustrated in FIG. 1. Of course, each controller 24a, 24b, or other controller, may send control signals via other wired or wireless signal, and the present invention should not be limited as described herein. Likewise, control leads 22a, 22e may also be via other wired or wireless signals and also should not be limited as described herein.

The control panel 16 may receive any input signal from the controllers 24a, 24b, or other like controllers and generate any output signal to control the motors 18a-18e as may be apparent to one of ordinary skill in the art. Preferably, the input and/or output signals may be MIDI protocol signals, although the present invention should not be limited to MIDI as the control signals may be any other like protocol allowing control thereof.

In an exemplary embodiment, as illustrated in FIG. 1, motor 18a may be connected to the master volume of a first channel of the audio amplifier 12, motor 18b may be connected to the gain dial of the first channel thereof, motor 18c may be connected to the master volume of a second channel, and motor 18d may be connected to the gain dial of the second channel. Since each motor may be individually controlled, a controller when activated may cause the master volume of each channel to lower while simultaneously raising the gain on each channel, or vice versa. By manipulating individual dials and/or switches, a user may change the particular sound emanating from the audio amplifier using a single or minimal number of controllers.

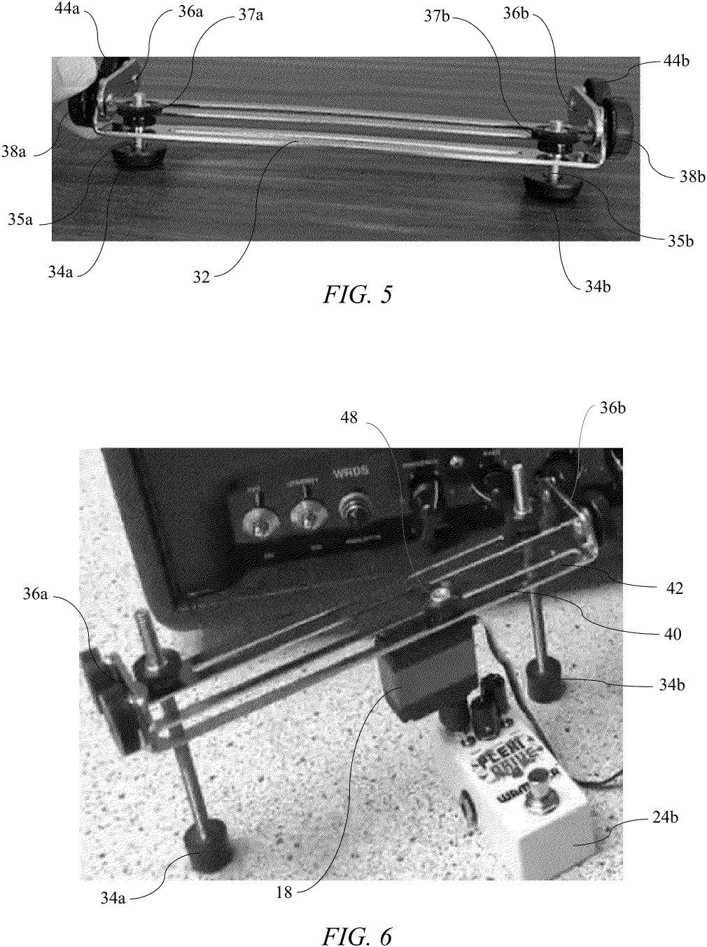

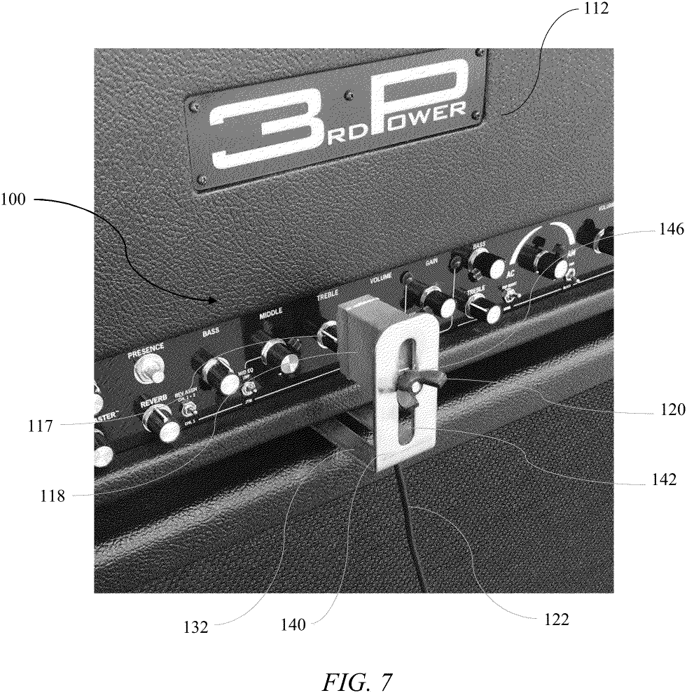

To enable mounting of the motors on the dials of an electronic device, bracket 30 may be utilized, as illustrated in FIGS. 2-6. Specifically, bracket 30 may comprise a base 32 through which may be disposed, on opposite ends thereof, feet 34a, 34b that may be adjustable in height. Extending from the base 32 may be rotatable sidewalls 36a, 36b which may rotate from a vertical position, as illustrated in FIGS. 2-4 to a horizontal position, as illustrated in FIGS. 5-6 via knobs 38a, 38b, which may be utilized to loosen and tighten the sidewalls 36a, 36b, respectively, to the base 32. Attached from one sidewall 36a to the other sidewall 36b may be a rotatable motor connection element 40 having a slot 42 or a plurality of slots and/or apertures therein. The rotatable motor connection element 40 may be rotatable via knobs 44a, 44b that may be used to loosen and/or tighten the motor connection element 40 to the first and second sidewalls 36a, 36b. Thus, the rotatable properties of the components of the bracket 30 may allow the positioning and use of the bracket in many different positions, as shown in FIG. 1.

For example, as illustrated in FIG. 4, a motor 18 may be attached to the motor connection element 40 through the slot 42. Specifically, threaded shaft 46 having a tightening knob 48 thereon may be used to tighten the motor within the slot 42. The motor 18 may have a shaft 19 extending therefrom that is rotatable via the motor 18 either directly or through reduction gears, which may be interconnected to a dial and/or switch, as described above. As shown in FIG. 4, the motor 18 may extend roughly horizontally based on the positioning of the motor connection element 40. When controlling the motor 18, as described above, the shaft 19 extending from the motor 18 may turn the dial or flip the switch.

Alternatively, a user may still manually control the knob or switch of the electronic device connected thereto by loosening the tightening knob 48, thereby allowing the motor 18 and, thus, the connected dial, to be manually rotated. Therefore, if a user wishes to make a manual adjustment, he or she may not need to remove the motor 18 from the dial or switch and need only loosen the knob 48. Likewise, if a user wishes to adjust the starting position of the dial or switch controlled by the motor 18, then he or she may loosen the knob 48, manually rotate the motor and, thus, the dial of the electronic device, into a new starting position, and then tighten the knob 48 again. To do so, it is preferred that the threaded shaft 46 and the shaft 19 extending from the motor 18 be aligned such that rotating the motor 18 on the threaded shaft also rotates the shaft 19 extending from the motor 18.

As illustrated in FIG. 4, the motor 18 may be attached to an extension element 50 that may be connected to the motor connection element 40 through the slot 42 via a knob 52 and threaded shaft 54, which may be utilized to loosen and/or tighten the same on the motor connection element 40. The extension element 50 may allow the motor 18 to be connected to a dial or a switch that is not in line with other dials and/or switches on an electronic device. The extension element 50 may be any length and, thus, any dial or switch in any placement on an electronic device may be reached by the control system 10 of the present invention. Any number of extension elements may extend from the motor connection element 40 to reach any number of dials and/or switches that are not aligned with the motor connection element 40.

FIGS. 5-6 illustrate an alternate arrangement of the bracket 30, wherein the sidewalls 36a, 36b are disposed in a horizontal configuration so that the motor connection element 40 lays flat. In such an arrangement, the motor 18 may be mounted with the shaft 19 extending therefrom vertically downward. As illustrated in FIG. 6, the motor 18 is mounted so that the shaft 19 extending from the motor 18 is connected to a dial on a top of the foot switch 24b. As noted above, rotation of the sidewalls 36a, 36b and/or the motor connection element 40 via knobs 38a, 38b and/or 44a, 44b, may allow motors to be connected to dials and switches in many different arrangements and configurations.

The feet 34a, 35b may be adjusted in height depending on where the bracket 30 may be positioned to interact with dials and/or switches, as described herein. For example, the feet may have threaded legs 35a, 35b extending therefrom, respectively, and may further have tightening knobs 37a, 37b for tightening the same to the base 32 of the bracket 30. As illustrated in FIG. 5, the threaded legs 35a, 35b may be relatively short; alternatively, the threaded legs 35a, 35b may be relatively long, as illustrated in FIG. 6, depending on the position desired, and the legs may thus be swapped depending on the desired positioning of the bracket 30. The threaded legs 35a, 35b may be adjusted in height upwardly or downwardly by loosening the tightening knobs 37a, 37b, rotating the threaded legs within respective threaded apertures within the base 32, and tightening the tightening knobs 37a, 37b.

Therefore, the bracket 30, as described herein, may be utilized to attach one or more control motors to one or more dials and/or switches on an electronic device, providing independent, automatic, and/or simultaneous control of each of the desired dials and/or switches. The bracket 30 may be disposed in a plurality of different configurations and positions to reach dials and/or switches that may extend horizontally from an electronic device, vertically from an electronic device, or in any position between horizontal and vertical.

FIG. 7 illustrates a control system 100 in an alternate embodiment of the present invention. Specifically, the control system 100 comprises a plurality of components that allow a user to control one or more dials and/or switches that may be on an electronic device. In the example shown in FIG. 7, the control system 100 controls a single dial or switch on an audio amplifier 112, although the control system 100 may be used to control a dial or switch on any electronic device. More specifically, as illustrated herein, the control system 100 may control a single dial or switch that controls the sound generated by one or more musical instruments that may be electronically connected to the audio amplifier 112, or any other electronic device, audio device, sound processor, or other like device that may affect the sound generated by the musical instruments.

The control system 100 may comprise a control panel (not shown) having a programmable interface that may allow motor 118 or additional motors not shown herein, to be controlled thereby. The motors 118 may be interconnected or otherwise engaged to a dial 117 or switch extending from the electronic device, such as the audio amplifier 112.

Specifically, motor 118 may comprise a housing having, on one side thereof, a shaft (not shown) extending therefrom that turns with the spinning of the motor therein, either directly or, more preferably, through a series of reduction gears. On a reverse side of the motor 118 may be a threaded connection shaft 146 that is disposed through bracket 130 that holds the motor 118 in place via nut 120. Control lead 122 may extend from and interconnect to the motor 118 and the controller (not shown), thereby controlling the precise activation and control of the motor 118 connected thereto. In a preferred embodiment, the control lead 122 may extend from the bottom of the housing so as not to interfere with the threaded connection shaft 146 and its connection to the bracket 130; however, it should be noted that the control lead 122 may extend from any position and location of the housing and the invention should not be limited as described herein.

To enable mounting of the motor 118 on the dial or switch 117 of an electronic device, one or more brackets 130 may be utilized. Specifically, bracket 30 may comprise a base 132 disposed roughly horizontally and a motor connection element 140 extending vertically roughly perpendicular to the base 132. The motor connection element may have an extended slot 142 therein allowing the threaded shaft 146 to be disposed therethrough and tightened thereto via the nut 120. The vertical placement of the motor may thus be configured by moving the threaded shaft 146 up or down within the slot 142 and tightening the nut thereto to hold in place. The bracket 130 may be positioned such that the base 132 extends under the electronic device and may be positioned to fit snugly to the bottom thereof, thereby preventing rotation of the same when the motor 118 spins the dial 117.

Therefore, the bracket 130 may be utilized to engage a single motor 118 to a dial or switch, as needed. Thus, a plurality of brackets 130 may be individually placed to engage a plurality of motors to a plurality of dials or switches, respectively.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A control system for controlling a plurality of dials and switches simultaneously comprising:
an electronic device comprising a first dial or switch;
a first motor having a shaft, wherein the shaft interacts with the first dial or switch;
a control panel, wherein the control panel controls the first motor which in turn controls the first dial or switch;
a controller interconnected with the control panel, wherein manipulation of the controller causes the control panel to engage the motor, thereby controlling the first dial or switch; and
a bracket comprising a base and a motor connection element, wherein the first motor connection element is connected to the first motor and is configured to hold the first motor in place on the bracket.

2. The control system of claim 1 wherein the electronic device is an audio device.

3. The control system of claim 1 wherein the electronic device is an audio amplifier.

4. The control system of claim 1 wherein the motor connection element is rotatably connected to the base.

5. The control system of claim 1 wherein the bracket comprises at least one foot extending from the base.

6. The control system of claim 5 wherein the at least one foot is adjustable in position relative to the base.

7. The control system of claim 1 wherein the motor connection element comprises an aperture, wherein the first motor comprises a housing and the housing comprises a shaft extending therefrom, wherein the shaft is disposed through the aperture on the motor connection element.

8. The control system of claim 1 wherein the motor connection element comprises a vertical configuration and a horizontal configuration relative to the base.

9. The control system of claim 1 wherein the electronic device comprises a second dial or switch and further comprising:
a second motor having a shaft, wherein the shaft interacts with the second dial or switch,.

10. The control system of claim 9 wherein the motor connection element is connected to the second motor and is configured to hold the second motor in place on the bracket.

11. The control system of claim 9 wherein the motor connection element comprises an aperture, wherein the first motor comprises a housing and the housing comprises a shaft extending therefrom, wherein the shaft extending from the first motor is disposed through the aperture on the motor connection element, and further wherein the second motor comprises a housing and the housing comprises a shaft extending therefrom wherein the shaft extending from the second housing is disposed through the aperture on the motor connection element.

12. The control system of claim 9 wherein the motor connection element comprises a first aperture and a second aperture, wherein the first motor comprises a housing and the housing comprises a shaft extending therefrom, wherein the shaft extending from the first motor is disposed through the first aperture on the motor connection element, and further wherein the second motor comprises a housing and the housing comprises a shaft extending therefrom wherein the shaft extending from the second housing is disposed through the second aperture on the motor connection element.

13. The control system of claim 9 wherein the first motor and the second motor and individually and separately controllable.

14. A bracket for connecting a motor controller to a dial or switch on an electronic device, the bracket comprising:
a base element;
a first sidewall extending from a first side of the base element;
a second sidewall extending from a second side of the base element; and
a motor connection element bridging between the first sidewall and the second sidewall, wherein the motor connection element is configured to hold a first motor thereon, the first motor having a shaft extending therefrom, wherein the shaft is configured to engage a dial or a switch on an electronic device.

15. The bracket of claim 14 wherein the motor connection element is configured to hold a second motor thereon.

16. The bracket of claim 14 wherein the motor connection element comprises a first aperture and the first motor is configured to be mounted within the first aperture.

17. The bracket of claim 16 wherein the motor connection element is configured to hold a second motor thereon, wherein the second motor is configured to be mounted within the first aperture.

18. The bracket of claim 16 wherein the motor connection element comprises a second aperture and the motor connection element is configured to hold a second motor thereon, wherein the second motor is configured to be mounted within the second aperture.

19. The bracket of claim 14 wherein the motor connection element comprises a vertical configuration and a horizontal configuration relative to the base, wherein the motor connection element is configured to rotate between the vertical configuration and the horizontal configuration.

20. The bracket of claim 14 further comprising:
an extension element having a first end and a second end, the first end of the extension element attached to the motor connection element, wherein the extension element is configured to hold the first motor thereon.

21. A bracket for connecting a motor controller to a dial or switch on an electronic device, the bracket comprising:
a base element;
a motor connection element extending roughly perpendicular from the base element, wherein the motor connection element is configured to hold a first motor thereon, the first motor having a shaft extending therefrom, wherein the shaft is configured to engage a dial or a switch on an electronic device.

22. The bracket of claim 21 wherein the motor connection element comprises a first aperture and the first motor is configured to be mounted within the first aperture.

23. The bracket of claim 16 wherein the first aperture comprises a slot running longitudinally through the motor connection element, wherein the slot is configured to allow the first motor to be mounted at different positions along the motor connection element.
